(19) United States
(12) Patent Application Publication
(10) Pub. No.: US 2025/0322473 A1
(43) Pub. Date: Oct. 16, 2025

(54) METHOD AND SYSTEM FOR COURSE ASSESSMENT IN A LEARNING MANAGEMENT SYSTEM

(71) Applicant: D2L Corporation, Kitchener (CA)

(72) Inventors: Andrew PRONK, Kitchener (CA); Kevin HO, Kitchener (CA); Daniel PENNER, Kitchener (CA); Michael MOORE, Kitchener (CA); Pauline TRAN, Kitchener (CA); Dale SCOTT, Kitchener (CA)

(21) Appl. No.: 18/989,360

(22) Filed: Dec. 20, 2024

Related U.S. Application Data
(60) Provisional application No. 63/615,842, filed on Dec. 29, 2023.

(51) Int. Cl. G06Q 50/20; G06Q 10/10

(52) U.S. Cl. CPC G06Q 50/20; G06Q 10/10

(57) ABSTRACT

A method and system for course assessment. The method including: receiving assessments from a plurality of assessors for at least one learner; reviewing the assessments for any issues by, for example, an AI agent; if issues are found, returning the assessments for additional review by, for example, an AI agent, if not, continuing; aggregating the assessments by, for example, an AI agent; reviewing the aggregated assessment for any aggregated issues by, for example, an AI agent; if aggregated issues are found, returning the aggregated assessments for additional review by, for example, an AI agent, if not, continuing; and providing the aggregated assessment to the learner. The system makes use of processor and memory to execute instructions to implement the method.

### FIELD

The present disclosure relates generally to course assessment in a learning management system. More particularly, the present disclosure relates to a method and system for course assessment with multiple assessors, in which the method and system may be supplemented by machine learning or artificial intelligence.

### BACKGROUND

Learning management systems (“LMS”) are becoming more popular for delivery of educational material in many different situations, whether in conventional areas like public/private educational institutions all the way through to corporations providing internal training to their employees. Some LMSs merely track student registration and progress while others deliver course content and materials directly to students.

With the rapid increase of LMSs and the organizations that use them and provide educational content, there is also an increase in the number of learners/students that may be taking a particular course. In some cases, the number of learners may be in the tens of thousands. In such large classes, it can be difficult for an instructor to provide an assessment for each learner in an efficient, fair and effective manner. While instructors have traditionally used teaching assistants, multiple choice (computer graded) testing, and the like, these techniques can have problems in relation to consistency, true assessment of capability, and the like.

In other situations, generally when a class is smaller, there may be multiple assessors assigned so that differing viewpoints or perspectives can be provided to an individual learner. In this situation, there can sometimes be a conflict between/among any feedback that each assessor is providing. As such, there is a need for an improved system and method for course assessment by multiple assessors in a learning management system.

The above information is presented as background information only to assist with an understanding of the present disclosure. No determination has been made, and no assertion is made, as to whether any of the above might be applicable as prior art with regard to the present disclosure.

### SUMMARY

In a first aspect, there is provided a method for course assessment, the method including: receiving assessments from a plurality of assessors for at least one learner; reviewing the assessments for any issues; if issues are found, returning the assessments for additional review, if not, continuing; aggregating the assessments; reviewing the aggregated assessment for any aggregated issues; if aggregated issues are found, returning the aggregated assessments for additional review, if not, continuing; and providing the aggregated assessment to the learner.

In some cases, the at least one learner may include a plurality of learners and the method may further include parsing the assessments per learner.

In some cases, the issues and aggregated issues may comprise one or more of: completeness, conflicting results, unusual wording, or the like.

In some cases, the aggregating the assessments may include: for language-based assessments: copying each of the language-based assessments into a document; and combining the assessments into a single assessment, and for grade-based assessments: applying a formula to the grade-based assessments to obtain a single assessment. In this case, the formula may include a weighted formula wherein the weighting is based on contact with the leaner, time, or the like. Further, in this case, the combining may include submitting the document to an AI agent for automatically processing into the single assessment.

In some cases, the additional review of issues or aggregated issues may include: review of one or more assignments that lead to the assessments by an AI agent; assessment by the AI agent; and aggregation of the AI agent assessment with the assessments.

According to another aspect herein, there is provided a system for course assessment, the system including: a processor; a memory; an assessment management module configured to use the processor to access the memory and execute computer readable instructions that cause the processor to: receive assessments from a plurality of assessors for at least one learner; review the assessments for any issues; if issues are found, return the assessments for additional review, if not, continuing; aggregate the assessments; review the aggregated assessment for any aggregate issues; if issues are found, return the aggregated assessments for additional review, if not, continuing; and provide the aggregated assessment to the learner.

Other aspects and features of the present disclosure will become apparent to those ordinarily skilled in the art upon review of the following description of specific embodiments in conjunction with the accompanying figures.

### BRIEF DESCRIPTION OF FIGURES

Embodiments of the present disclosure will now be described, by way of example only, with reference to the attached Figures.

FIG. 1 illustrates an example of a learning management system;

FIG. 2 illustrates an example of a computing device for communication with the learning management system of FIG. 1;

FIG. 3 illustrates an example of a course assessment module according to an embodiment herein;

FIG. 4 illustrates an example of an assessor management module according to an embodiment herein;

FIG. 5 illustrates an example of an assessment management module according to an embodiment herein;

FIG. 6 is a flowchart illustrating a method for assessor management according to an embodiment herein; and

FIG. 7 is a flowchart illustrating a method for assessment management according to an embodiment herein.

### DETAILED DESCRIPTION

The following description with reference to the accompanying drawings is provided to assist in a comprehensive understanding of example embodiments as defined by the claims and their equivalents. The following description includes various specific details to assist in that understanding but these are to be regarded as merely examples. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not intended to be limited to the bibliographical meanings, but, are merely used by the inventor to enable a clear and consistent understanding. Accordingly, it should be apparent to those skilled in the art that the following description of embodiments is provided for illustration purpose only and not for the purpose of limiting the invention as defined by the appended claims and their equivalents.

Generally, the present disclosure provides a method and system for course registration. In particular, the embodiments of the system and method detailed herein provide for a method and system for course registration that includes access to promotional material, checking of pre-requisites/approval, and immediate registration for those with pre-requisites/approval.

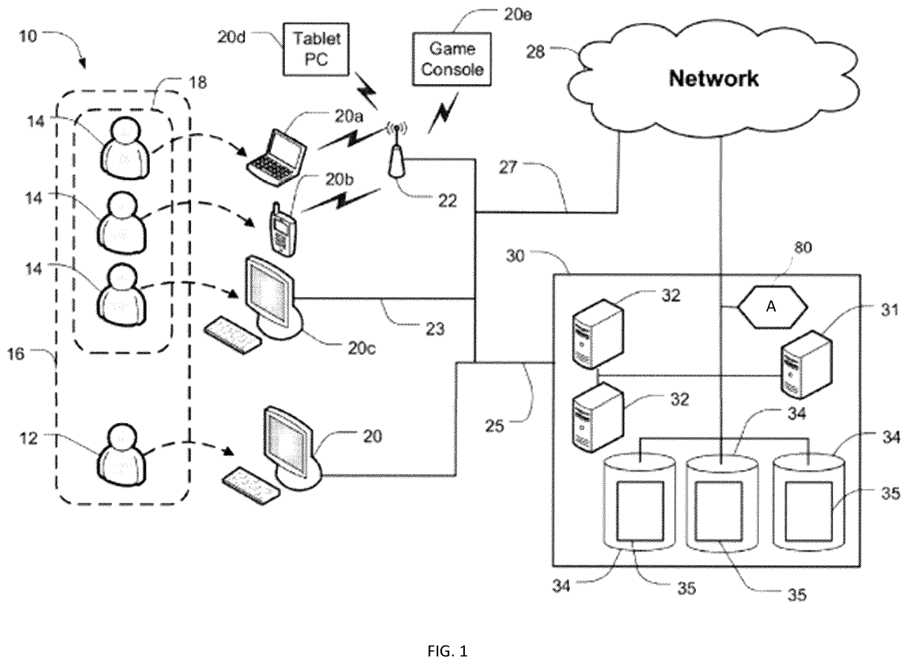

FIG. 1 illustrates an example embodiment of a learning management system 10 according to one embodiment. The learning management system 10 includes an educational service provider system 30, which can be accessed by various users 12, 14 via computer networks.

The users 12, 14 communicate with the educational service provider system 30 either directly or indirectly using any suitable computing device 20, such as, for example a desktop computer that has at least one input device (e.g., a keyboard and a mouse) and at least one output device (e.g., a display screen and speakers). Other examples of the computing device may include: a laptop 20a wirelessly coupled to an access point 22 (e.g., a wireless router, a cellular communications tower, etc.), a wirelessly enabled mobile device, smart phone or the like 20b, a terminal 20c over a wired connection 23, a tablet computer 20d, or a game console 20e over a wireless connection. The computing devices 20 may be connected to the educational service provider system 30 via any suitable communications channel. For example, the computing devices 20 may communicate to the educational service provider system 30 directly through a LAN/intranet or wireless network via a data connection 25, or using an external network, such as, for example, the Internet 28 over a data connection 27.

In some cases, one or more of the users 12 and 14 may be required to authenticate their identities in order to communicate with the educational service provider system 30. For example, the users 12 and 14 may be required to input a login name and/or a password or otherwise identify themselves to gain access to the learning management system 10. In other cases, one or more users (e.g., “guest” users) may be able to access the learning management system 10 without authentication. Such guest users may be provided with limited access, such as the ability to review only one or a few components of the course, for example, to decide whether they would like to enroll in a particular course.

The educational service provider system 30 generally includes a number of components for facilitating the provision of electronic learning services. For example, the educational service provider system 30 generally includes one or more processing devices 32 (e.g., servers), each having one or more processors. The processing devices 32 are configured to send information (e.g., HTML or other data) to be displayed on one or more computing devices 20, 20a, 20b and/or 20c to facilitate social electronic learning (e.g., course information). In some cases, the processing device 32 may be a computing device 20 (e.g., a laptop or a personal computer).

The educational service provider system 30 also generally includes one or more data storage devices 34 (e.g., memory, etc.) that are in communication with the processing devices 32, and could include a relational database (such as an SQL database), or other suitable data storage devices. The data storage devices 34 are configured to host data 35 relating to the courses offered by the service provider.

For example, the data 35 can include course frameworks, educational materials to be consumed by the users 14, historical records about assessments or grades of users 14 or assignments completed by the users 14, as well as various other information.

The data storage devices 34 may also store authorization criteria that define which actions may be taken by the users 12 and 14. In some cases, the authorization criteria may include at least one security profile associated with at least one role. For example, one role could be defined for users who are primarily responsible for developing an educational course, teaching it, and assessing work product from learners/students of the course. Users with such a role may have a security profile that allows them to configure various components of the course, to post assignments, to add assessments, to evaluate performance, and so on.

In some cases, some of the authorization criteria may be defined by specific users 40 who may or may not be part of the educational community 16. For example, users 40 may be permitted to administer and/or define global configuration profiles for the learning management system 10, define roles within the learning management system 10, set security profiles associated with the roles, and assign roles to particular users 12, 14 who use the learning management system 10. In some cases, the users 40 may use another computing device (e.g., a desktop computer 42) to accomplish these tasks.

The data storage devices 34 may also be configured to store other information, such as personal information about the users 12, 14 of the learning management system 10, information about which courses the users 14 are enrolled in, roles to which the users 12 and 14 are assigned, particular interests of the users 12,14, and historical information about the performance of the users 12, 14.

The processing devices 32 and data storage devices 34 may also provide other electronic learning management tools (e.g., allowing users to add and drop courses, communicate with other users using chat software, etc.), and/or may be in communication with one or more other vendors that provide various tools.

In some cases, the educational service provider system 30 may also have one or more backup servers 31 that may duplicate some or all of the data 35 stored on the data storage devices 34. The backup servers 31 may be desirable for disaster recovery to prevent undesired data loss in the event of an electrical outage, fire, flood or theft, for example. The backup servers 31 could be located at a remote storage location and the service provider system 30 could connect to the backup server 31 using a secure communications protocol to ensure that the confidentiality of the data 35 is maintained.

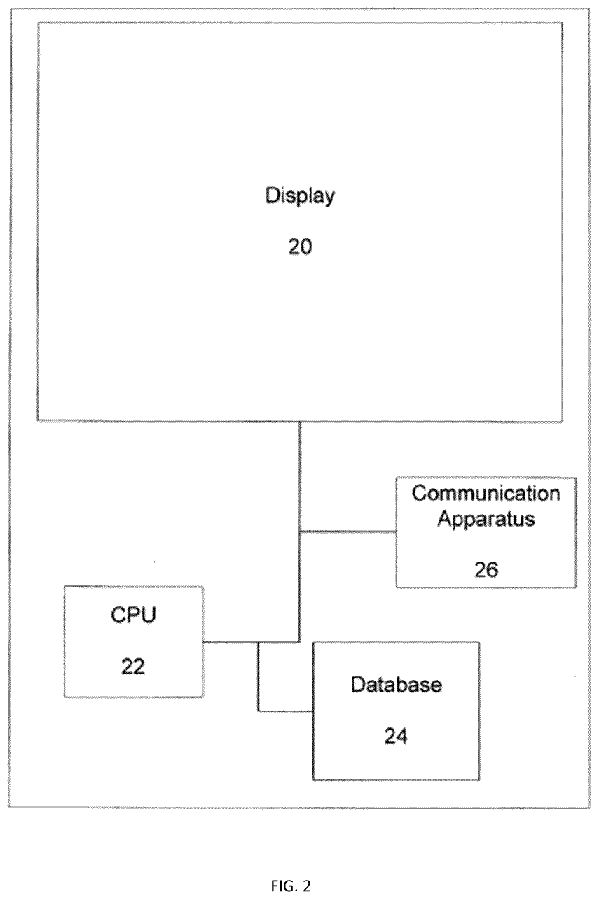

FIG. 2 is a schematic diagram of an example computing device 20, in this case, a mobile computing device, which communicates wirelessly. As shown, the computing device 20 comprises a processor 22, a memory 24, a communication apparatus 26, a display 28, and an input apparatus 29. A user 12, 14, uses the functions of the computing device 20 to communicate with the educational service provider system 30 as described herein.

Generally speaking, the users 12, 14 can use the learning management system 10 to communicate with the educational service provider system 30 to participate in, create, and consume electronic learning services, including enrolling in and participating in various educational courses. In some cases, the educational service provider system 30 may be part of or associated with a traditional “bricks and mortar” educational institution (e.g., an elementary school, a high school, a university or a college), another entity that provides educational services (e.g., an online university, a company that specializes in offering training courses, an organization that has a training department), an independent service provider (e.g., for providing individual electronic learning), or the like.

It should be understood that a “course” is not necessarily limited to formal courses offered by formal educational institutions. The course may generally include any form of learning instruction offered by an entity of any type. For example, the course may be a training seminar at a company for a small group of employees, a professional certification program with a larger number of intended participants (e.g., PMP, CMA, etc.), and so on.

It should also be understood that users 12, 14 may fall into various categories, including learners/students, instructors, guests, or the like. Further, one or more educational groups can be defined that involve one or more of the users 12, 14. For example, as shown in FIG. 1, the users 12, 14 may be grouped together in an educational group 16 representative of a particular course (e.g., History 101, French 254), in which the first user 12 is an “instructor” and is responsible for providing the course (e.g., organizing lectures, preparing assignments, creating educational content, etc.), while the other users 14 are “learners” or “students” that consume the course content (e.g., the users 14 are enrolled in the course to learn the course content). In some cases, the users 12, 14 may be associated with more than one educational group. For instance, the users 14 may be enrolled in more than one course, while the user 12 may be enrolled in a course and also responsible for teaching a course (which is common for example for graduate students).

In some cases, educational sub-groups may also be defined. For example, in FIG. 1, some users 14 are shown as part of an educational sub-group 18. The sub-group 18 may be defined in relation to a particular project or assignment (e.g., sub-group 18 may be a lab group) or based on other criteria. In some cases, due to the nature of electronic learning, the users 14 in a particular sub-group 18 need not physically meet but may collaborate together using various tools provided by the educational service provider system 30.

In some cases, the groups 16 and sub-groups 18 could include users 12, 14 that share common interests (e.g., interests in a particular sport), that participate in common activities (e.g., users that are members of a choir or a club), and/or have similar attributes (e.g. users that are male, users under twenty-one years of age, etc.).

As shown in FIG. 1, the educational service provider system 30 can include a course assessment module 80, which allows for an instructor to divide assignments among a group of assessors, manage the assessors, manage the assessments, and the like. The course assessment module 80 may also be remote from but connectable with the educational service provider system 30. The course assessment module 80 is expected to be particularly useful for courses in which a number of assessors assess the performance of an individual or group of students in a learning activity and provide feedback. It is becoming more common to see multiple, sometimes 2-3, evaluators/assessors assess a learning activity for an individual or group of students in order to reduce bias and improve equity of the assessment. The evaluators generally provide feedback and a grade. In conventional LMS', the feedback is typically compiled and provided to the learner(s) with minimal or no editing and the grade is typically averaged, for example, automatically or by a lead evaluator. However, this approach can lead to the learner receiving feedback that may be contradictory or confusing and potential issues with the final grade being set without additional review/consideration. For example, if the two assessors have very disparate views of an appropriate grade, the feedback may be conflicting and the assignment of an average grade may not be appropriate without further review. Embodiments of the system and method herein are intended to provide advanced assessment workflows to support assessments with multiple evaluators to evaluate a single learner or group of learners while keeping assessments more fair and equitable and also providing more cohesive feedback.

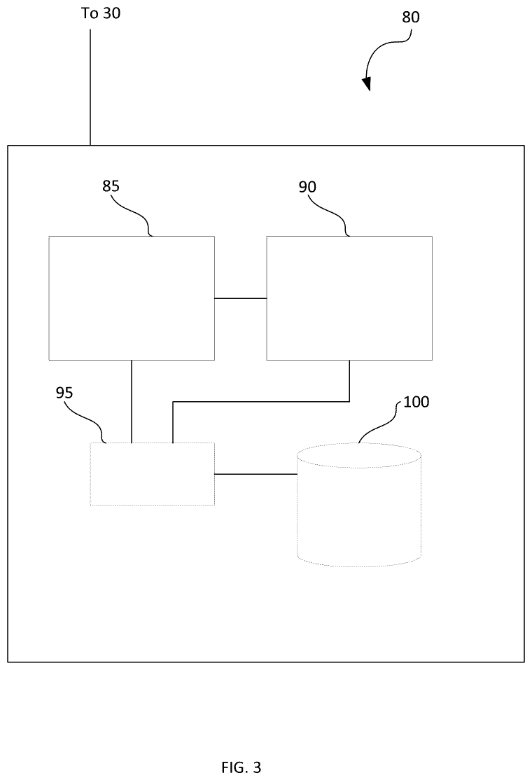

FIG. 3 illustrates a block diagram of the course assessment module 80 according to one embodiment. In this embodiment, the course assessment module 80 is operable to communicate with an instructor via, for example, the learning management system 10 and the computing device 20. In this embodiment, the course assessment module 80 includes an assessor management module 85 and an assessment management module 90. The course assessment module 80 may include its own processor 95 and memory storage/database 100 or may rely on those available through the educational service provider system 30 or otherwise.

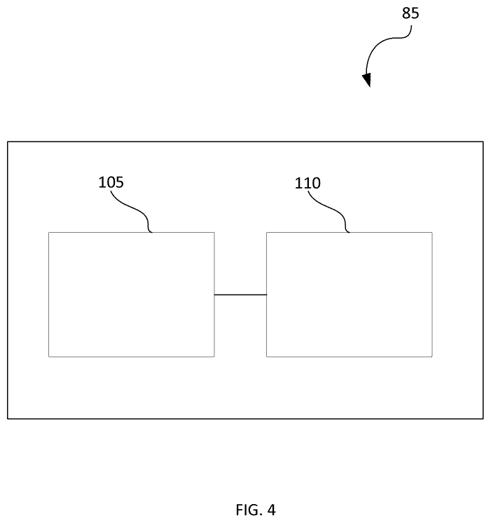

FIG. 4 illustrates the assessor management module 85, which includes an assessor selection module 105 and an assessor evaluation module 110. When an instructor is preparing for a course, the assessor management module 85 can be accessed to allow the instructor to search for, recruit and manage assessors. In particular, the accessor selection module 105 can include a list of available assessors or can include an automated system to recruit potential assessors, for example, post a notice seeking assessors and then allow input of various information by the recruited assessors. For example, the assessor selection module 105 may make use of social media sites to post assessor opportunities and may then have access to information on social media sites, metadata, cookies or the like to gather information on assessors and/or identify potential assessors to contact with notice of an opportunity. The information/data collected by the assessor management module 85 may be stored in, for example, the database 100. The database used for storage may be local, such as the database 100 of the assessor management module 85, or remote and accessed via the educational service provider system 30 or the like.

Generally speaking, the assessors may be either internal (already connected with the learning management system) or external (found outside of the learning management system). This may include guest assessors or the like. The assessors can be selected based on expertise, average time to complete assessment after being assigned, previous performance in the same course, and any other factors that might be available in the information collected on each assessor. In the case of external assessors, the assessor management module 85 may also automatically manage login information and access permissions for assessors, particularly those that are selected.

In either event, the instructor can review the list of accessors, including information available on the assessors and select accessors for the course. As the course progresses and/or after the course, the assessor evaluation module 110 allows the instructor, or possibly learners/students, to provide evaluations for the assessors. The assessor evaluation module 110 can also keep track of various metrics/statistics for each assessor, such as, Quality of Service (QOS) metrics, for example, time to complete assessments, number of assessments, or the like. The information/data received via the assessor evaluation module 110 can also be fed back into the assessor selection module 105 for review by instructors when selecting assessors for subsequent classes or the like. The assessor evaluation module may include an AI Agent, such as a Large Language Model (LLM) or the like, for summarizing or aggregating evaluation results. In some cases, the instructor may select and assign assessors per assignment rather than per course or in some other way. In some cases, the system may allow for delegate assessors to be picked by selected assessors if the selected assessor can't complete an assignment or the like.

Referring again to FIG. 3, the assessment management module 90 allows for input of assessment results by assessors and manages the assessments for provision to the learners. In general, the assessment management module 90, is configured to provide an “aggregated assessment” to the learner, in which assessments from each of multiple assessors are curated together and sent/published to the learner. This is intended to provide the learner with a single, cohesive artifact for consideration. An aggregated assessment may include:

Feedback: after aggregation, the feedback is edited such that the learner receives a more cohesive message on how they can improve their performance.

Grade: In some circumstances, a simple average of all grades may be appropriate. However, in some circumstances, the assessment management module 90 may flag the learner/grade for additional review, for example, where one instructor has spoken to the student and others have not. This will allow for different weighting or overrides to be applied.

Rubric: Each criterion of a rubric can be aggregated and the feedback on each criterion can also be aggregated similar to that for “feedback” above.

Outcome assessment: Learning outcomes (learning objectives) are often evaluated using a scale. Somewhat similar to “grade” above, these results can be aggregated to provide an appropriate assessment to the learner.

Generally speaking, the aggregate evaluation will not overwrite the assessments in the system but rather will represent a new evaluation that is created and saved in the assessment management module 90.

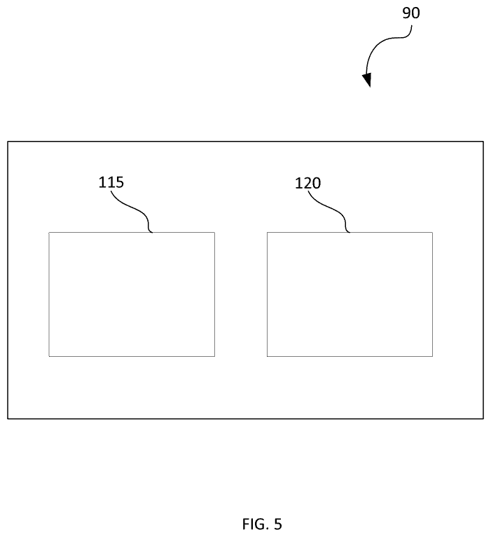

FIG. 5 illustrates the assessment management module 90. The assessment management module 90 can include a language processing module 115 and a grade processing module 120.

In one embodiment, the language processing module 115 is configured to aggregate all language-based assessments/comments into a single file/document/assessment/feedback artifact that can then be edited by a lead assessor/instructor in order to consolidate the assessments and/or resolve any inconsistencies prior to publishing/sending to a student. For example, the language processing module 115 may include computer instructions stored in memory and executed by a processor to perform the function of receiving language-based assessments, aggregating them into a single file, and notifying the lead assessor to review the content.

Similarly, the grade processing module 120 is configured to receive all grade-based assessments and perform a calculation to determine a grade result for the leaner. For clarity, grade-based assessments may include numeric assessments, “letter” assessments (“A”, “B”, “C”), proficiency scale assessments (“exceeds”, “meets”, “below” an expected proficiency level) or the like, which indicate some grade or level as a result in a course. In some cases, this may be an average of the assessment results. In some cases, there may be some rounding of the result. Still further, there may be a weighting of the results included in the calculation. For example, a lead assessor or teaching assistant assigned specifically to that learner may have more weight assigned to the result and less weight is assigned to other results. The weighting may be done based on time (most recent vs older) or other factors. Further, other mathematical aggregation methods know in the art may be used/automatically calculated.

In other embodiments, the language processing module 115 and/or grade processing module 120 may include alternate automatic aggregation approaches. For example, the language processing module 115 could include or be linked to a generative artificial intelligence agent (such as a large language model (LLM) or the like) that would be provided with and combine language-based feedback to provide an aggregation/integration of what assessors/evaluators have included as their feedback for the assessment. This could integrate/summarize general feedback, the feedback for a given criteria, or the like between or among multiple assessors. In this case, the LLM would provide a single assessment that includes the points received in the multiple assessments. The LLM could also check for completeness of the review based on a learning objective or rubric.

As one example, where a rubric is used, there may be some disparity between how assessors assess a learner. The assessment management module 90 can evaluate a language-based rubric (i.e. some value associated with the criteria score) that is assessed by one evaluator at a given level (level A) and evaluated by a different evaluator that the learner has achieved a criteria at a different level (level D). Using an LLM, assessment management module 90 can evaluate the assessments for language in level A and level D and decide if one of those levels or even if level B or C is best suited for the evaluation. The LLM could do this by: comparing the general feedback given on the assignment; comparing the levels awarded on related criteria of the rubric (in some cases, the LLM may initially determine what is related criteria and what is not); and comparing the level awarded for a criteria related to the rubric.

In another example, where learning outcomes (learning objectives) are used, the assessment management module 90 can use an LLM provided with two or more disparate outcome assessments and, similar to the description above for rubrics, create an aggregated assessment that resolves any conflicts and is ready to be published/provided to the learner.

In calculating grade-based assessments, mathematical formulas or AI agents could be used to determine a result or determine if there is a conflict. In some cases, an Al agent such as an LLM could be used to compare the language used in the assessment with a grade-based assessment and determine if there is a disparity in the grade-based assessment and the language-based assessment. Similar to the above, the discrepancy could be resolved by seeking further input and/or by involving an AI agent comparing results or the like.

In yet another embodiment, an AI agent may serve as one of the multiple assessors or possibly the primary assessor. In this situation, the AI agent could be provided with each learner's work product, such as an essay or the like, and the AI agent could serve as a consistent assessor for all learners and the AI agent's mark could be compared/combined with the human assessors in the class. In this situation, there may also be some weighting given to different assessors, including the AI agent assessor. Alternatively, an AI agent could serve as a “tie-breaker” if there are two or more assessors whose marks are different but of equal weight. In this case, the AI agent could be assigned to the assessment, mark the submission(s), and then the various evaluations (including that of the AI agent) could be used to determine a final grade, rubric evaluation, or level of achievement for an outcome. As an example: Assessor 1 has evaluated a student with an overall mark as D while Assessor 2 has evaluated with an A. Since these marks are significantly different, it would generally indicate that a re-mark would be wise. However, re-marks typically require significant time and attention from an evaluation team. As such, instead of investing human time to do a re-mark an AI Agent such as an LLM could assess the student independent of the previous two evaluations. This could provide a third data point allowing the aggregation to be classified as a C or a B since the “average” of an “A” and “D” could end up as either. It will be understood that, in some cases, the AI Agent assessment may still result in an “A” or “D” assessment.

In a further embodiment, in the context of a single assessor or multi assessor scenario, an AI agent could alternatively or also be used as an assessor of the assessment to determine if there are any issues with a single assessment or with an aggregated assessment. Assessments could be evaluated for issues such as completeness, inconsistencies, or the like. For example, an AI agent could be used to identify when two or more qualitative assessments are different on the same assignment (one assessor indicates paragraph structure is good and marks a 90% while another assessor indicates paragraph structure is poor and marks a 50%). In this situation, the AI agent could suggest a re-mark or a re-assessment of the standard by the same or another assessor or attempt to resolve the conflict in some other fashion, such as performing an automatic independent assessment, or the like. Generally speaking, this concept could hold true for any case where there is an oddly significant split between assessors/evaluators: on a specific learning outcome; on a specific rubric criteria; on an overall score for a rubric; on specific assignments or quiz questions; or the like. It will be understood that examples of other types of conflicts may include: the rubric criteria score of spelling/sentence structure was high, however in the overall feedback an assessor notes poor spelling/sentence structure; the learning outcome for grammar was high, however in the overall feedback for grammar am assessor notes poor grammar; or the like

An AI agent can also be configured to assess an assessment even in a single assessor context. In this case, the AI agent could be used to detect issues such as incompleteness, conflicting messaging, unusual wording/language that might confuse a learner, or the like. Similar to the examples above, if a criterion of a rubric relating to spelling was marked highly and a learning outcome relating to spelling was marked poorly, the AI agent could detect the potential issue and notify the assessor or lead assessor of the conflicting messaging. As noted herein, the AI agent may sometimes automatically resolve a conflict, missing information or the like by assessing the work of the learner, by reviewing other assessments of the learner, or the like.

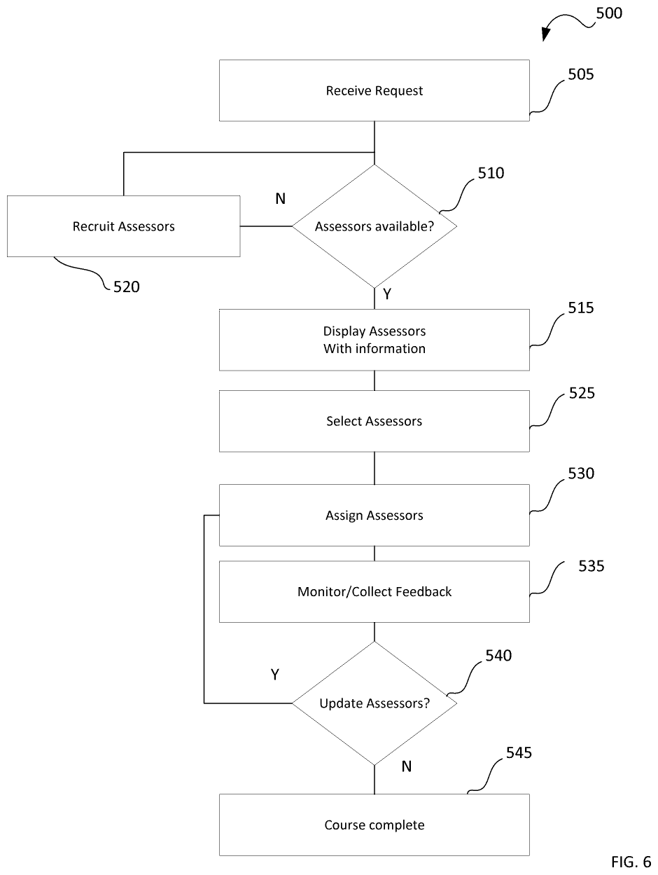

FIG. 6 is a flowchart illustrating a method 500 for assessor management according to an embodiment. The method 500 starts when the system (e.g. the course assessment module 80) receives, from an instructor, a request to manage assessors at 505. The system then determines if there are potential assessors available at 510. Determining if potential assessors are available may include already available potential assessors that have previously been registered or, in some cases, may include determining if there is one or more AI agents available as assessors. If there are, the system may then begin displaying available potential assessors at 515. If not, the system may conduct a recruitment drive at 520 to bring in potential assessors, as described above. If necessary, the system can continue to check the number of potential assessors and continue recruitment until an appropriate number of assessors are available or until all assessors are selected. After the display of assessors at 515, the instructor selects assessors at 525. As noted above, some assessors may be pre-approved while others may need further information, which can be gathered either automatically or by follow up from the instructor or the like. At 530, the assessors can be assigned to all or a subset of students/learners in the class. Multiple assessors may be assigned to at least some of the learners. The assignment of assessors may be made by the instructor, automatically, or the like. Once assigned, the system monitors and collects feedback on assessors at 535. Monitoring and collecting feedback can include metrics/statistics such as time to complete assessments, performance review feedback from the instructor/students, or the like. As noted above, sometimes the feedback on assessors can include an AI agent assessing the assessment. In some cases, the system can be configured to periodically update the assessors assigned to leaners/students or different subsets of learners/students and this can be checked at 540. If yes, the assignment of assessors can be performed again at 530. If not, the system can wait for an indication that the course has ended at 545. It will be understood that feedback may also be received following the end of the course.

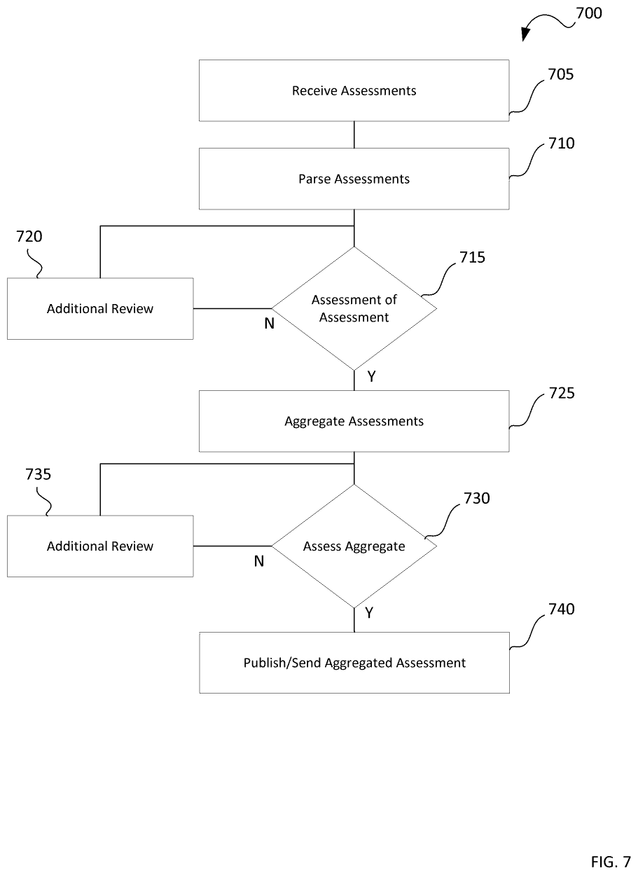

FIG. 7 is a flowchart illustrating a method 700 for assessment management according to an embodiment. The method 700 starts when the system (e.g. the assessment management module 90) receives a plurality of assessments, at 705. The assessments could be multiple assessments for one learner or multiple assessments for each of a group of learners and may be for various courses, assignments, quizes or the like. If necessary, the plurality of assessments is then parsed, at 710, to separate out assessments by student, by course, assignment or the like. At 715, the assessments for a learner in a particular course, assignment, or the like can be assessed for any issues such as completeness, conflicts or the like. As noted above, the assessments can be assessed for any issues by an AI agent, machine learning system, a reviewer or the like. If there are issues, the assessment(s) may be subject to additional review at 720 by, for example, the relevant or a lead assessor, by an AI Agent, or the like for resubmission for assessment of the assessment, or for further processing or review.

At 725, the assessments for a learner in a particular course, assignment, or the like are aggregated into a single assessment. As noted above, in some cases, written/language assessments may be handled differently from grade assessments. Further, the aggregation may be performed semi-automatically or automatically by various approaches, including for example, automatic aggregation and review by an assessor, automatic aggregation by an AI agent, machine learning, or the like without additional review, or the like. At 730, the aggregated assessment for a learner in a particular course, assignment, or the like can be further assessed for any aggregated issues such as completeness, conflicts, unusual wording, or the like, again using an AI agent, machine learning system, a reviewer or the like. In the case of the aggregated assessment, it is also useful to ensure that any language-based assessments are integrated so that it appears to be a single assessment rather than a group of separate assessments. If there are issues, the aggregated assessment(s) may be subject to additional review at 735, which can be similar to the review at 720. Once the aggregated assessment is complete, an aggregated assessment can be published/presented to each of the leaners at 740.

In the preceding description, for purposes of explanation, numerous details are set forth in order to provide a thorough understanding of the embodiments. However, it will be apparent to one skilled in the art that these specific details may not be required. In other instances, structures may be shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A method for course assessment, the method comprising:
receiving assessments from a plurality of assessors for at least one learner;
reviewing the assessments for any issues;
if issues are found, returning the assessments for additional review, if not, continuing;
aggregating the assessments;
reviewing the aggregated assessment for any aggregated issues;
if aggregated issues are found, returning the aggregated assessments for additional review, if not, continuing; and
providing the aggregated assessment to the learner.

2. A method according to claim 1, wherein the at least one learner comprises a plurality of learners and the method further comprises parsing the assessments per learner.

3. A method according to claim 1, wherein the issues or aggregated issues comprise one or more of: completeness, conflicting results, and unusual wording.

4. A method according to claim 1, wherein the aggregating the assessments comprises:
for language-based assessments:
copying each of the language-based assessments into a document; and
combining the assessments into a single assessment, and
for grade-based assessments:
applying a formula to the grade-based assessments to obtain a single assessment.

5. A method according to claim 4, wherein the formula comprises a weighted formula wherein the weighting is based on contact with the leaner.

6. A method according to claim 4, wherein the automatically combining comprises submitting the document to an AI agent for automatically processing into the single assessment.

7. A method according to claim 1, wherein the additional review of issues or aggregated issues comprises:
review of one or more assignments that lead to the assessments by an AI agent;
assessment by the AI agent; and
aggregation of the AI agent assessment with the assessments.

8. A system for course assessment, the system comprising:
a processor;
a memory;
an assessment management module configured to use the processor to access the memory and execute computer readable instructions that cause the processor to:
receive assessments from a plurality of assessors for at least one learner;
review the assessments for any issues;
if issues are found, return the assessments for additional review, if not, continuing;
aggregate the assessments;
review the aggregated assessment for any aggregate issues;
if issues are found, return the aggregated assessments for additional review, if not, continuing; and
provide the aggregated assessment to the learner.
